(19) United States
(12) Patent Application Publication
(10) Pub. No.: US 2009/0140846 A1
(43) Pub. Date: Jun. 4, 2009

(54) METHOD AND APPARATUS FOR CONTROLLING A VEHICLE FUNCTION

(76) Inventor: Mark Rutledge, Vista, CA (US)

Correspondence Address: DIRECTED ELECTRONICS, INC., 1 VIPER WAY, VISTA, CA, 92061, US

(21) Appl. No.: 11/950,142

(22) Filed: Dec. 4, 2007

(51) Int. Cl. B60R 25/10

(52) U.S. Cl. 340/426.11

(57) ABSTRACT

A method, a means, and an apparatus for controlling at least one function in a vehicle via a remote control unit are disclosed. An immobilizer element previously housed in an ignition key or in a first remote control unit apparatus is removed. According to the present teachings, a remote control unit housing of a remote control unit apparatus is provided, which is adapted to house the previously removed immobilizer element therein an opening, wherein the immobilizer element is secured therein via a door. A vehicle user may then use the provided remote control unit housing to control at least one function in a vehicle.

### BACKGROUND

1. Field

The present disclosure generally relates to methods and apparatuses for controlling at least one function in a vehicle.

2. Related Art

As demand for greater wireless control over security and convenience in vehicle functionality grows, so to does the number of remote control devices grow. Many modern new vehicles are offered with some sort of remote control device for wirelessly controlling security and/or convenience functions in a vehicle. Typically, however, stock automotive remote control units are limited in functionality. Therefore, vehicle users often turn to aftermarket solutions for additional functionality in an automotive remote control device.

One challenge to providing aftermarket remote control solutions is dealing with an immobilizer element that is typically embedded within the stock automotive remote control unit and/or a stock ignition key. An immobilizer element is a device which must be detected by a vehicle immobilizer element detector device, or a vehicle will not start. Therefore, if a user attempts to start a vehicle ignition merely using an access key (which does not contain an immobilizer element), and no immobilizer element is in detectable range of the vehicle immobilizer element detector device, attempts at starting the vehicle ignition will fail. Therefore, if a vehicle user purchases a vehicle with a remote control unit which has an embedded immobilizer element, and then the vehicle user subsequently purchases an aftermarket remote control unit, the vehicle user must still carry the original remote control unit having the immobilizer element therein so that the vehicle ignition will start. Hence, the vehicle user must carry two remote control units, which is cumbersome and inconvenient.

Also, it is well known that vehicle ignition keys containing immobilizer elements are quite expensive, relative to a access key, therefore having spare ignition keys can be quite expensive. Access keys typically will not start an ignition, because they do not have an immobilizer element embedded therein. It would be cost effective and useful if a means were available to allow a vehicle user to start a vehicle ignition with an access key and have the same confidence in knowing that not just anyone can start the vehicle ignition with an access key.

Therefore a need exists for a solution to the aforementioned problems, which is inexpensive, reliable, easy to install, and easy to use. The present teachings provide such a solution.

### SUMMARY

In one illustrative exemplary embodiment a method for controlling at least one vehicle function with a remote control unit is disclosed. The method comprises the steps of removing an immobilizer element from an ignition key, then providing a remote control unit housing, wherein the remote control housing is adapted to house the immobilizer element. A final step of the method is housing the immobilizer element therein the remote control unit.

In one embodiment a method for controlling at least one function in a vehicle with a second remote control unit is disclosed. The method comprises the steps of removing an immobilizer element from a first remote control unit housing, then providing a second remote control unit housing, wherein the second remote control unit housing is adapted to house the immobilizer element therein. A final step is housing the immobilizer element therein the second remote control unit housing.

In one embodiment, a remote control unit apparatus adapted to control at least one function in a vehicle is disclosed. The apparatus comprises an immobilizer element, removed from an ignition key and a remote control unit housing, adapted to house the immobilizer element therein.

In one embodiment, a remote control unit apparatus adapted to control at least one function in a vehicle is disclosed. The apparatus comprises an immobilizer element, removed from a first remote control unit housing, and a second remote control unit housing adapted to house the immobilizer element therein.

### BRIEF DESCRIPTION OF THE DRAWINGS

Embodiments of the present disclosure will be more readily understood by reference to the following figures, in which like reference numbers and designations indicate like elements.

FIG. 1 illustrates a flow diagram for a method for controlling at least one function in a vehicle with a remote control unit, wherein an immobilizer element is removed from an ignition key, in accordance with one embodiment of the present teachings.

FIG. 2 illustrates a flow diagram for a method for controlling at least one function in a vehicle with a second remote control unit, wherein an immobilizer element is removed from a first remote control unit, in accordance with one embodiment of the present teachings.

FIG. 3A illustrates a top plan view of one embodiment of the present teachings of a remote control apparatus, adapted to house an immobilizer element therein.

FIG. 3B illustrates a top plan view of the embodiment of FIG. 3A, with a remote control unit housing open to accept the immobilizer element.

FIG. 3C illustrates an ignition key having an immobilizer element therein, in accordance with one embodiment of the present teachings.

FIG. 3D illustrates insertion of the immobilizer element into a remote control unit housing via an opening, according to one embodiment of the present teachings.

FIG. 4A illustrates a top plan view of a remote control apparatus, adapted to house an immobilizer element therein, having an opening, in accordance with one embodiment of the present teachings.

FIG. 4B illustrates a top plan view of the remote control apparatus, having the immobilizer element being inserted into the opening, in accordance with one embodiment of the present teachings.

FIG. 4C illustrates a top plan view of the remote control apparatus, having an immobilizer element inserted therein, showing an opening door closed, in accordance with one embodiment of the present teachings.

FIG. 5 illustrates a perspective view of a remote control unit housing, adapted to house an immobilizer element, in accordance with one embodiment of the present teachings.

### DETAILED DESCRIPTION

### Overview

A method and apparatus will now be described for removing an immobilizer element from an ignition key and/or removing an immobilizer element from a first remote control unit and housing the removed immobilizer element in a remote control unit housing. By employing the techniques disclosed by the present teachings, a user can consolidate multiple remote control devices into one remote control unit. Additionally, by using the techniques disclosed herein, a user is able to reduce cost of having multiple spare keys, as will be described further below.

As used herein the term, “at least one function” refers to literally any security and/or convenience vehicle functionality which can be remotely controlled, and all such functionalities are contemplated to be within the scope of the present disclosure. The term, “at least one function” spans a range of security (e.g., warn-away, alarm, siren, flashing lights, etc.) and/or convenience (e.g., remote-start, door-lock/unlock, trunk lock/unlock, etc.) functions in a vehicle. Literally any security or convenience function in a vehicle falls within the scope of the intended use of the term, “at least one function”, and the forgoing are intended to be examples of the myriad of potential functions for which the present disclosure may be used in a vehicle. In one embodiment, the term “at least one function” refers to a remote start function, wherein a remote control unit is adapted to start a vehicle ignition. In another embodiment, the term, “at least one function” refers to security functions, such as for example, inter alia, an alarm and door locking/unlocking. Examples of such security functions are further described in U.S. Pat. No. 5,157,375 to Drori, entitled, “Electronic Vehicle Security System”; U.S. Pat. No. 5,103,221 to Memmola, entitled, “Remote-control Security System and Method of Operating the Same”, all of which are incorporated by reference in their entirety as if disclosed herein in full.

As used herein, the term “immobilizer element” is intended to mean a device which is adapted to disable an ignition system in a vehicle. Examples of such devices may be found in U.S. Pat. No. 6,781,507 to Birchfield, et al., entitled, “Remote Start, passive anti theft security system” and/or U.S. Pat. No. 6,982,631 to Kemper, entitled, “Automotive security system with self-biasing bypass immobilizer”, both of which are incorporated by reference in their entirety, as if disclosed herein in full.

As used herein the term “remote control unit” is intended to mean a device having an ability to remotely control one or more features and/or functions in a vehicle, wireless. Examples of such features/functions comprise, inter alia, security and access features and functions. Examples of such devices may be found in U.S. Pat. No. 4,890,108 to Drori et al., entitled, “Multi-Channel Remote Control Transmitter”; U.S. Pat. No. 5,650,774 to Drori, entitled, “Electronically Programmable Remote Control Access System”; U.S. Pat. No. 6,561,151 to Wisnia et al., entitled, “Remote Control Car Starter”; U.S. Pat. No. 4,887,064 to Drori et al., entitled, “Multi-featured Security System with Self-Diagnostic Capability”; U.S. Pat. No. 6,467,448 to Wisnia et al., entitled, “Remote Engine Starter System”; U.S. Pat. No. 4,922,224 to Drori et al., entitled, “Electronic Vehicle Security System”; U.S. Pat. No. 5,534,845 to Issa et al., entitled, “Advanced Automotive Automation and Security System”, all of which are incorporated by reference in their entirety, as if disclosed herein in full.

It will be appreciated that as used herein the term, “remote control unit housing” describes a housing (e.g., a casing, an enclosure, etc.) for a remote control unit. As such, the remote control unit housing may have one or more functional actuators (e.g., buttons) adapted to actuate a security and/or convenience function in a vehicle, as described above with respect to the term, “at least one function”.

As used herein the term, “physical key” is composed of a material such as for example, metal or plastic. Within the scope of the term physical key are two distinct types of keys, an “ignition key” and an “access key”. As used herein, an ignition key is a physical key having an immobilizer element encased therein. As used herein, an access key is a physical key which gives a user access to certain vehicle functions, such as for example unlocking doors, trunk, switching on electrical power to the vehicle circuitry; however, the access key will not, by itself, start the ignition, unless an immobilizer element in a proximity detectable by vehicle, such as for example if the immobilizer element is housed within a remote control unit.

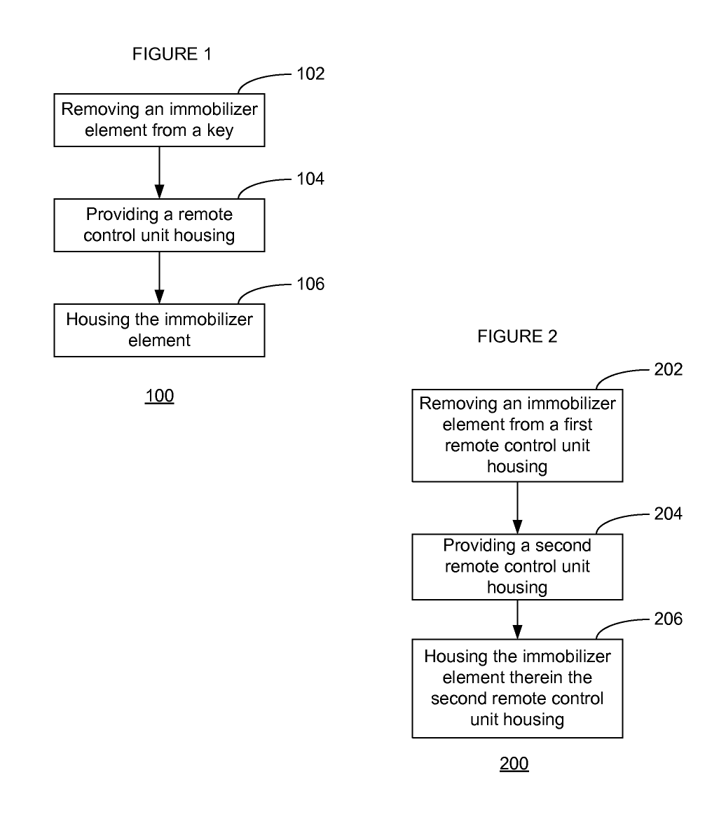

Referring now to FIG. 1, a method 100 for controlling at least one function in a vehicle with a remote control unit is disclosed. In one embodiment, the method 100 comprises, removing an immobilizer element from an ignition key, providing a remote control unit housing, and housing the immobilizer element.

In one embodiment, the method 100 for controlling at least one function in a vehicle with a remote control unit begins at a STEP 102 of removing an immobilizer element from an ignition key. Removing the immobilizer element may be accomplished in a variety of ways, such as for example cutting the immobilizer element out of the ignition key. An immobilizer element functions in conjunction with an ignition key to start a vehicle ignition. If a user attempts to start a vehicle ignition with a key which has no immobilizer element in a proximity detectable by the vehicle, ignition of the vehicle will fail. In many modern vehicles, immobilizer elements are encased within an ignition key, which is different from an access key. An access key will only work to start a vehicle ignition if an immobilizer element is in a proximity detectable by the vehicle's wireless communication system, such as for example when an immobilizer element is housed within a remote control unit in a proximity close enough to the vehicle that the vehicle's wireless communication system can detect the immobilizer element, such a for example if an immobilizer element is housed within a remote control unit on a same key chain as the access key.

In a next STEP 104 of providing a remote control unit housing, a remote control housing is provided, which is adapted to house the immobilizer element therein. In one embodiment, a remote control unit housing is provided that comprises an opening (e.g., a cavity, an orifice, etc.) which is adapted to contain an immobilizer element previously removed from an ignition key. The provided remote control unit housing may also, optionally contain an opening “door” (as will be described further below), which functions to open to allow insertion of the immobilizer element therein and further functions to “close” such that the immobilizer element is thereby “housed” within the remote control unit housing.

In a final STEP 106 of housing the immobilizer element, the immobilizer element previously removed from the ignition key in STEP 102 is housed inside an interior of the remote control unit housing previously provided in STEP 104. In one embodiment, the immobilizer element is housed inside an interior of an opening (e.g., a cavity, etc.) within the remote control unit housing.

In one embodiment of the method 100 for controlling at least one function in a vehicle with a remote control unit, an immobilizer element is removed from an ignition key and housed within a provided remote control unit housing. By using the present teachings, a user is able to use an access key to start a vehicle ignition, provided that the remote control unit housing is in a physical proximity which is detectable by the vehicle, such as for example on a same key ring as the access key. Due to the present disclosure, a user may now insert an immobilizer element into an aftermarket remote control unit housing, hang the aftermarket remote control unit housing on a same key ring as an access key, then start the vehicle ignition using the access key, because the immobilizer element is proximate the vehicle and presumptively in detectable range.

Referring now to FIG. 2, one embodiment of a method 200 for controlling at least one function in a vehicle with a second remote is disclosed. In one embodiment, the method 200 comprises, removing an immobilizer element from a first remote control unit housing, and providing a second remote control unit housing, and housing the immobilizer element therein the second remote control unit housing, as will be described further below.

In one embodiment, the method 200 for controlling at least one function in a vehicle with a second remote begins at a STEP 202 of removing an immobilizer element from a first remote control unit housing. It will be appreciated that many modern vehicles today come equipped from the factory with a key FOB designed to protect a vehicle owner from theft and to control various convenience aspects of a vehicle. An immobilizer element is typically built into the key FOB body, such that a vehicle can detect the immobilizer element proximity to the vehicle and therefore allow ignition of the vehicle engine when the ignition key is used. If a vehicle owner decides to purchase an aftermarket remote security/convenience device (which come with a key FOB), the vehicle user must then carry two key FOBs, primarily because the immobilizer element in the factory key FOB must be in close physical proximity to the vehicle in order for the engine to start. The present teachings provide a solution to this problem of a vehicle user needing to carry two key FOBs, as will be further described below.

In a next STEP 204 of providing a second remote control unit housing, the second remote control unit housing is adapted to house the immobilizer element previously removed from the first remote control unit housing. The adapted second remote control unit housing comprises an opening or cavity therein for the purpose of housing the immobilizer element. In one illustrative exemplary embodiment, a first remote control unit housing is provided with a vehicle when it is newly purchased from a manufacturer, whereas a second remote control unit is an aftermarket remote control unit housing.

In a next STEP 206 of housing the immobilizer element therein the second remote control unit housing, the immobilizer element is inserted into an opening or cavity adapted for accepting the immobilizer element therein the second remote control unit housing. The immobilizer element is then enclosed within the second remote control unit housing, such that the immobilizer element does not fall out of the second remote control unit. At the completion of this STEP 206, the user may use the second remote control unit in conjunction with an access key to start the vehicle ignition. Previously, a user would not have been able to start the vehicle ignition with an access key coupled with the second remote control unit, because the immobilizer element would have been missing. However, because the second remote control unit contains the immobilizer element, a user may simply use an access key in conjunction with the second remote control unit.

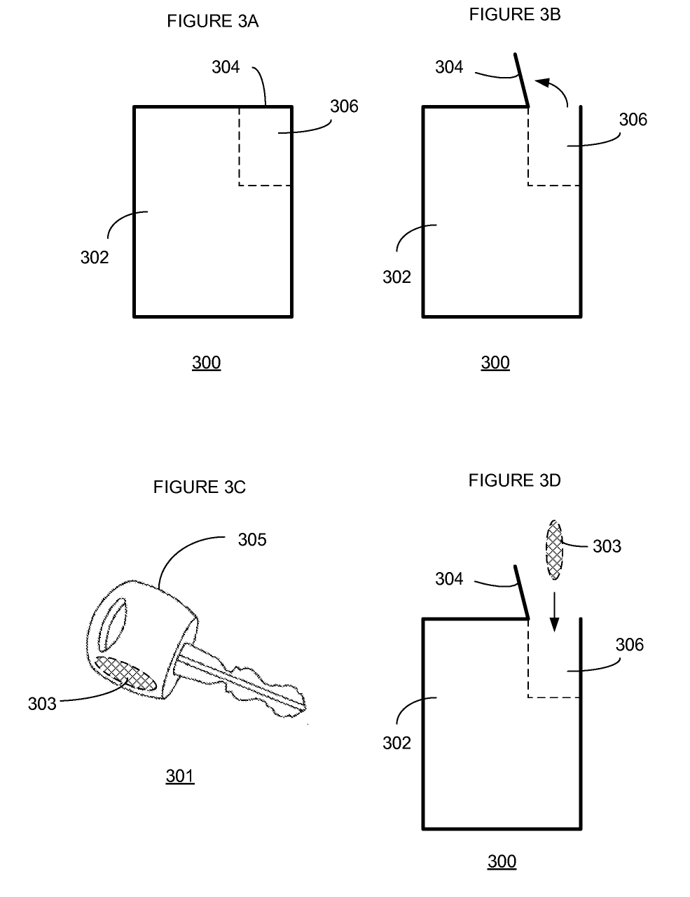

Referring now to FIGS. 3A-D, one embodiment of a remote control unit apparatus 300, adapted to control at least one function in a vehicle is disclosed. The remote control unit apparatus 300 comprises an immobilizer element 303 and a remote control unit housing 302. In one illustrative exemplary embodiment, the remote control unit apparatus 300 comprises an immobilizer element 303, which is removed from an ignition key 305 and then the immobilizer element 303 is inserted into a remote control unit housing 302, wherein the remote control unit housing 302 is adapted to house the immobilizer element 303 therein. That is, the remote control unit housing 302 is adapted to have an opening (e.g., a cavity) 306 adapted to fit the immobilizer element 303 therein. The remote control unit housing 302 may also, optionally contain an opening door 304, which functions to open to allow insertion of the immobilizer element 303 therein the opening and further the door functions to close such that the immobilizer element is thereby “housed” (secured) within the remote control unit housing 302.

FIG. 3A illustrates a remote control unit housing 302 having an opening 306 and a door 304, wherein the door 304 is closed and no immobilizer element 303 is inside the opening 306. As described above, the opening 306 is adapted to fit the immobilizer element 303 therein, and the door 304 is adapted to secure the immobilizer element 303 therein the remote control unit housing 302. FIG. 3B illustrates the remote control unit housing of FIG. 3A, having the door 304 in an open position, ready to accept the immobilizer element 303 into the opening 306. FIG. 3C illustrates an ignition key 305 having the immobilizer element 303 therein. According to the present teachings, the immobilizer element 303 is removed from the ignition key 305. A variety of methods are contemplated for removing the immobilizer element 303 from the ignition key 305, such as for example cutting a hole into the ignition key 305 proximate the immobilizer element 303, whereby the immobilizer element 303 may readily be removed. FIG. 3D illustrates the remote control unit housing 302 of the present teachings, having the door 304 open and the immobilizer element 303 inserted therein. The door 304 is then closed, thereby securing the immobilizer element 303 inside the remote control unit housing.

It will be appreciated that the ignition key 305, having the immobilizer element 303 removed therefrom will be unable to start a vehicle ignition, unless the immobilizer element 303 is independently within a proximity to the vehicle, such that the vehicle immobilizer detection system can affirmatively detect the immobilizer element 303. Due to removal of the immobilizer element, the ignition key 305 has effectively been transformed into an access key, which may be used to unlock/lock doors, the truck, and turn on limited electrical functions (e.g., radio, lights, etc.), but will not start the vehicle ignition, unless the immobilizer element 303 is proximate the vehicle. As a result of the present teachings, a vehicle user may now start a vehicle ignition with an access key, if the remote control unit housing 302 is within range of the vehicle immobilizer detection system.

As will be appreciated, the cost of an ignition key 305 is substantially greater than the cost of an access key, primarily due to the presence of an immobilizer element 303. As a result, if a vehicle user desires to have a spare key for starting a vehicle ignition, it is quite expensive. Because of the present disclosure, a vehicle user may inexpensively purchase an access key as a spare key and use the access key in conjunction with the remote control unit apparatus of the present teachings.

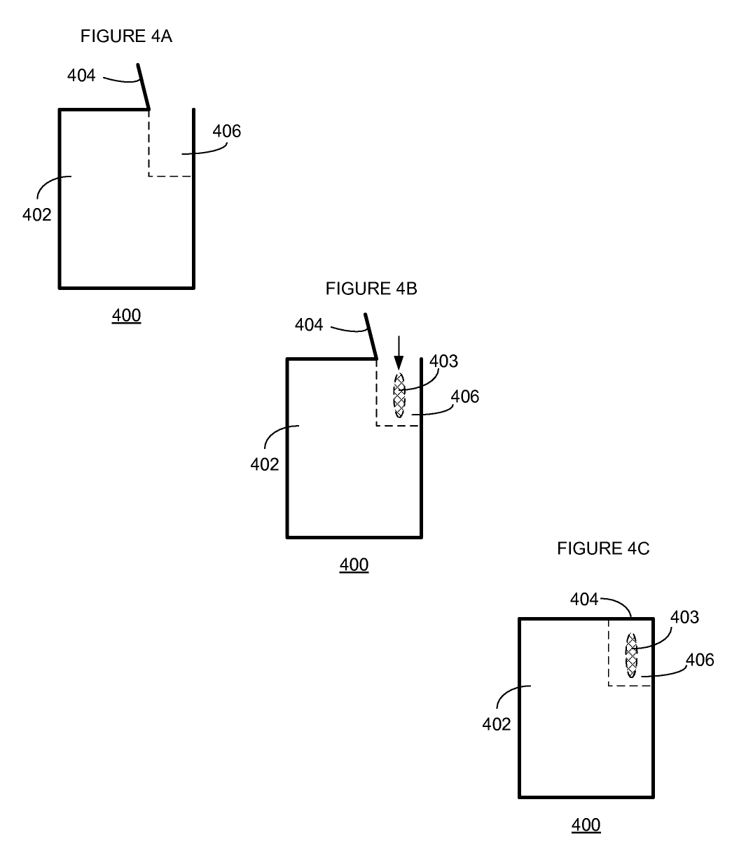

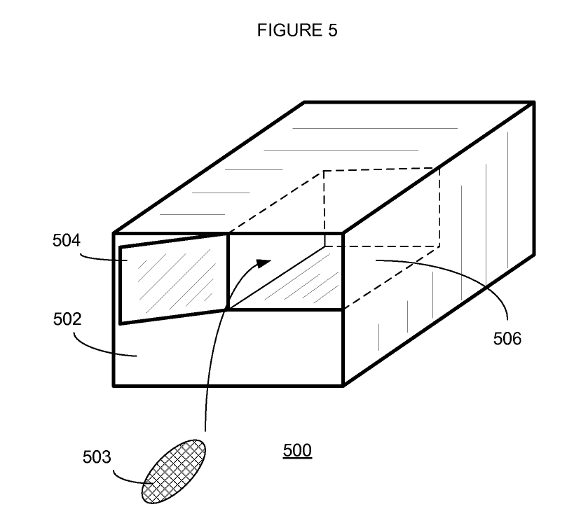

Referring now to FIGS. 4A-4C, a remote control unit apparatus 400, adapted to control at least one function in a vehicle is disclosed. In one embodiment, the remote control unit apparatus 400 comprises an immobilizer element 403 and a second remote control unit housing 402. It will be appreciated that the second remote control unit housing 402 is the housing for the remote control unit apparatus 400, as will now be described in greater detail. An immobilizer element 403 is removed from a first remote control unit housing (not shown), by a plurality of possible methods, such as for example cutting a hole in the first remote control unit housing large enough to remove the immobilizer element 403. It will be appreciated that in many cases a first remote control unit housing is provided by an original equipment manufacturer, such as for example an automobile manufacturer. However, a first remote control unit housing may have been provided to a vehicle owner by an aftermarket source as well.

FIG. 4A illustrates a second remote control unit housing 402 of a remote control unit apparatus 400 having an opening 406 and a door 404, wherein the door 404 is open and the opening 406 is adapted to accommodate an immobilizer element 403 therein. FIG. 4B illustrates a second remote control unit housing 402 of a remote control unit apparatus 400, having an immobilizer element 403 disposed within an opening 406, wherein the immobilizer element 403 has been removed from a first remote control unit apparatus (not shown). FIG. 4C illustrates remote control unit housing 402 of a remote control unit apparatus 400, having an immobilizer element 403 disposed within an opening 406, wherein the immobilizer element 403 is secured inside the remote control unit apparatus 400 by a door 404.

FIG. 5 illustrates a perspective view of one embodiment of a remote control unit 500, comprising a remote control unit housing 502, an opening 506, a door 504, and an immobilizer element 503. It will be appreciated that the immobilizer element 503 as illustrated in FIG. 5 has been extracted from either another remote control unit (not shown) or an ignition key (not shown). The remote control unit 500 is adapted to accommodate an immobilizer element 503 from either another remote control unit or from an ignition key, such that the immobilizer element 503 may be inserted into the opening 506 of the remote control unit housing 502, and thereafter secured inside the remote control unit 500 by the door 504. Although not shown in FIG. 5, the immobilizer element is secured within the remote control unit 500 by closing the door 504, after the immobilizer element 503 has been inserted into the remote control unit housing 502. A vehicle user may now use the remote control unit 500 in conjunction with an access key to start a vehicle ignition, if the remote control unit 500 is in a proximity to the vehicle detectable by the vehicle.

The foregoing description illustrates exemplary implementations, and novel features, of aspects of a remote control apparatus and method. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A method for controlling at least one function in a vehicle with a remote control unit, comprising:
(a) removing an immobilizer element from an ignition key;
(b) providing a remote control unit housing, wherein the remote control unit housing is adapted to house the immobilizer element therein, and;
(c) housing the immobilizer element therein the remote control unit housing.

2. A method for controlling at least one function in a vehicle with a second remote control unit, comprising:
(a) removing an immobilizer element from a first remote control unit housing;
(b) providing a second remote control unit housing, wherein the second remote control unit housing is adapted to house the immobilizer element removed in STEP (a) therein the second remote control unit housing, and;
(c) housing the immobilizer element therein the second remote control unit housing.

3. A method for controlling a remote starting system in a vehicle using a remote control unit, comprising:
(a) removing an immobilizer element from an ignition key;
(b) providing a remote control unit housing, wherein the remote control unit housing is adapted to house the immobilizer element therein, and;
(c) housing the immobilizer element therein the remote control unit housing.

4. A method for controlling a remote starting system in a vehicle using a second remote control unit, comprising:
(a) removing an immobilizer element from a first remote control unit housing;
(b) providing a second remote control unit housing, wherein the second remote control unit housing is adapted to house the immobilizer element removed in STEP (a) therein the second remote control unit housing, and;
(c) housing the immobilizer element therein the second remote control unit housing.

5. A method for controlling a security system in a vehicle via a remote control unit, comprising:
(a) removing an immobilizer element from an ignition key;
(b) providing a remote control unit housing, wherein the remote control unit housing is adapted to house the immobilizer element therein, and;
(c) housing the immobilizer element therein the remote control unit housing.

6. A method for controlling a security system in a vehicle via a second remote control unit, comprising:
(a) removing an immobilizer element from a first remote control unit housing;
(b) providing a second remote control unit housing, wherein the second remote control unit housing is adapted to house the immobilizer element removed in STEP (a) therein the second remote control unit housing, and;
(c) housing the immobilizer element therein the second remote control unit housing.

7. A remote control unit apparatus, adapted to control at least one function in a vehicle, comprising:
(a) an immobilizer element, removed from an ignition key, and;
(b) a remote control unit housing, adapted to house the immobilizer element removed from the ignition key.

8. A remote control unit apparatus, adapted to control at least one function in a vehicle, comprising:
(a) an immobilizer element, removed from a first remote control unit housing, and;
(b) a second remote control unit housing, adapted to house the immobilizer element removed from the first remote control unit housing.

9. A remote control unit apparatus, adapted to control a remote starting system in a vehicle, comprising:
(a) an immobilizer element, removed from an ignition key, and;
(b) a remote control unit housing, adapted to house the immobilizer element removed from the vehicle key.

10. A remote control unit apparatus, adapted to control a remote starting system in a vehicle, comprising:
(a) an immobilizer element, removed from a first remote control unit housing, and;
(b) a second remote control unit housing, adapted to house the immobilizer element removed from the first remote control unit housing.

11. A remote control unit apparatus, adapted to control a security system in a vehicle, comprising:
(a) an immobilizer element, removed from an ignition key, and;
(b) a remote control unit housing, adapted to house the immobilizer element removed from the ignition key.

12. A remote control unit apparatus, adapted to control a security system in a vehicle, comprising:
(a) an immobilizer element, removed from a first remote control unit housing, and;
(b) a second remote control unit housing, adapted to house the immobilizer element removed from the first remote control unit housing.

13. A means for controlling at least one function in a vehicle with a remote control unit means, comprising:
(a) means for removing an immobilizer element means from an ignition key means;
(b) means for providing a remote control unit housing means, wherein the remote control unit housing means is adapted to house the immobilizer element means therein;
(c) means for housing the immobilizer element means therein the remote control unit housing means, and;
(d) means for activating the at least one function in the vehicle via the remote control unit means.

14. A means for controlling at least one function in a vehicle with a second remote control unit means, comprising:
(a) means for removing an immobilizer element means from a first remote control unit housing means;
(b) means providing a second remote control unit housing means, wherein the second remote control unit housing means is adapted to house the immobilizer element means removed in STEP (a) therein the second remote control unit housing means;
(c) means for housing the immobilizer element means therein the second remote control unit housing means, and;
(d) means for activating the at least one function in the vehicle via the second remote control unit means.

15. A means for controlling a remote starting system in a vehicle using a remote control unit means, comprising:
(a) means for removing an immobilizer element means from an ignition key means;
(b) means for providing a remote control unit housing means, wherein the remote control unit housing means is adapted to house the immobilizer element means therein;
(c) means for housing the immobilizer element means therein the remote control unit housing means, and;
(d) means for activating the remote starting system in the vehicle via the remote control unit means.

16. A means for controlling a remote starting system in a vehicle using a second remote control unit means, comprising:
(a) means for removing an immobilizer element means from a first remote control unit housing means;
(b) means for providing a second remote control unit housing means, wherein the second remote control unit housing means is adapted to house the immobilizer element means removed in STEP (a) therein the second remote control unit housing means;
(c) means for housing the immobilizer element means therein the second remote control unit housing means, and;
(d) means for activating the remote starting system in the vehicle via the second remote control unit means.

17. A means for controlling a security system in a vehicle via a remote control unit means, comprising:
(a) means for removing an immobilizer element means from an ignition key means;
(b) means for providing a remote control unit housing means, wherein the remote control unit housing means is adapted to house the immobilizer element means therein;
(c) means for housing the immobilizer element means therein the remote control unit housing means, and;
(d) means for activating the security system in the vehicle via the remote control unit means.

18. A means for controlling a security system in a vehicle via a second remote control unit means, comprising:
(a) means for removing an immobilizer element means from a first remote control unit housing means;
(b) means for providing a second remote control unit housing means, wherein the second remote control unit housing means is adapted to house the immobilizer element means removed in STEP (a) therein the second remote control unit housing means;
(c) means for housing the immobilizer element therein the second remote control unit housing means, and;
(d) means for activating the security system in the vehicle via the second remote control unit means.
